(19) United States
(12) Patent Application Publication
(10) Pub. No.: US 2019/0190278 A1
(43) Pub. Date: Jun. 20, 2019

(54) CHARGING CONTROL METHOD, CHARGRING APPARATUS AND CHARGER CIRCUIT THEREFOF

(71) Applicant: RICHTEK TECHNOLOGY CORPORATION, Zhubei City (TW)

(72) Inventors: Wei-Hsu Chang, Hsinchu (TW); Jing-Meng Liu, Hsinchu (TW); Ta-Yung Yang, Taoyuan (TW)

(21) Appl. No.: 16/133,818

(22) Filed: Sep. 18, 2018

(30) Foreign Application Priority Data
Dec. 14, 2017 (TW) 106144031

(51) Int. Cl. H02J 7/00

(52) U.S. Cl. CPC H02J 7/007

(57) ABSTRACT

A charger circuit converts a supply voltage of a DC power supply to a charging voltage and a charging current to charge a battery. A battery charging method includes: setting the supply voltage to an initial voltage; checking whether the charging voltage reaches a predetermined voltage level; when the charging voltage is lower than the predetermined voltage level, delivering a control signal to the DC power supply to reduce the supply voltage; when the charging voltage or the charging current is reduced accordingly, delivering the control signal to the DC power to increase the supply voltage; and repetitively reducing and/or increasing the supply voltage until the charging voltage reaches the predetermined voltage level.

### CROSS REFERENCE

The present invention claims priority to TW 106144031, filed on Dec. 14, 2017.

### BACKGROUND OF THE INVENTION

### Field of Invention

The present invention relates to a charging control method. Particularly it relates to a charging control method which controls a supply voltage of a DC power according to a charging voltage or a charging current of a battery to reduce power loss during charging process. The present invention also relates to a charging apparatus and a charger circuit employing the charging control method.

### Description of Related Art

Referring to FIG. 1A, a prior art charger circuit 10 receives a supply voltage Vdc provided by a DC power supply 2 and converts the supply voltage Vdc to generate a charging power to charge a battery BAT. The charging power includes a charging voltage Vbat and a charging current Ibat. FIG. 1B shows curves of the charging voltage Vbat and the charging current Ibat when the prior art charger circuit 10 charges the battery BAT. In some occasions, the voltage drop between the supply voltage Vdc provided by the DC power supply 2 and the charging voltage Vbat of the battery BAT may be quite large to cause high power loss; however, the prior art charger circuit 10 does not respond to this issue. In some prior art, the prior art charger circuit 10 may detect temperature and reduce the charging current Ibat to lower the temperature when the temperature is overly high. However, to reduce the charging current Ibat will prolong the charging time; besides, the temperature detection is not very precise to accurately reflect the actual temperature.

Relevant prior patents are U.S. Pat. Nos. 6,100,667A, 8,816,648 B2 and 6,437,549 B1.

### SUMMARY OF THE INVENTION

From one perspective, the present invention provides a charging apparatus, comprising: a DC power supply; and a charger circuit configured to be coupled to the DC power supply, wherein the charger circuit includes: a power conversion circuit, configured to operably receive the DC power supply, and convert a supply voltage of the DC power supply to generate a charging power to charge a battery, wherein the charging power includes a charging voltage and a charging current; and a control unit, configured to operably control the power conversion circuit, wherein in a charging period, the control unit senses a voltage drop of the charger circuit, and adjusts the supply voltage according to the voltage drop to reduce the voltage drop; wherein the voltage drop indicates a difference between the supply voltage and the charging voltage.

In one embodiment, the control unit adjusts the supply voltage to reduce the voltage drop by the following steps: (A) setting the supply voltage to an initial voltage; (B) checking whether the charging voltage reaches a predetermined voltage level; (C) when the charging voltage is lower than the predetermined voltage level, the charger circuit delivering a control signal to control the DC power supply to reduce the supply voltage; (D) checking whether the charging voltage or the charging current is reduced corresponding to the step (C), wherein when the charging voltage or the charging current is reduced in response to the step (C), entering step (E); (E) the charger circuit delivering the control signal to control the DC power supply to increase the supply voltage; and (F) checking whether the charging voltage and/or the charging current is increased in response to the step (E); wherein: after the step (D), when the charging voltage and the charging current are not reduced in response to the step (C), returning to step (B); after the step (F), when the charging voltage and/or the charging current is increased in response to the step (E), returning to step (B).

In one embodiment, after the step (F), when the charging voltage or the charging current is not increased corresponding to the step (E), returning to step (E).

In one embodiment, the step of the control unit adjusting the supply voltage to reduce the voltage drop further includes step (D1): after the step (D), when the charging voltage and the charging current are not reduced in response to the step (C), waiting for a first predetermined time period before returning to step (B).

In one embodiment, the step of the control unit adjusting the supply voltage to reduce the voltage drop further includes step (F1): after the step (F), when the charging voltage and/or the charging current is increased in response to the step (E), waiting for a second predetermined time period before returning to step (B).

In one embodiment, the step of the control unit adjusting the supply voltage to reduce the voltage drop further includes step (F2): after the step (F), when the charging voltage or the charging current is not increased in response to the step (E), waiting for a third predetermined time period before returning to step (E).

In one embodiment, the step of the control unit adjusting the supply voltage to reduce the voltage drop further includes step (C1) and/or (E1), and step (G), wherein: the step (C1) includes: after the step (C), checking whether the supply voltage changes in response to the step (C), and entering the step (D) when the supply voltage changes in response to the step (C), otherwise entering the step (G); the step (E1) includes: after the step (E), checking whether the supply voltage changes in response to the step (E), and entering the step (F) when the supply voltage changes in response to the step (C), otherwise entering the step (G); wherein the step (G) includes at least one of the following operations: (1) stopping adjusting the supply voltage; (2) repetitively delivering the control signal to control the DC power supply for plural times and checking whether the supply voltage is increased or is reduced accordingly, wherein when a count number of repetitively delivering the control signal reaches a predetermined count number and the supply voltage is neither increased nor reduced accordingly, stopping adjusting the supply voltage; and/or (3) the charger circuit adjusting the charging current to a predetermined minimum current.

In one embodiment, during or after the step (B), when the charging voltage reaches the predetermined voltage level, stopping adjusting the supply voltage.

In one embodiment, during the step (C), the supply voltage is reduced by a predetermined voltage step, or during the step (E), the supply voltage is increased by a predetermined voltage step.

In one embodiment, the DC power supply is one of the followings: an adaptor, a power bank, or a power supply circuit, which is compliant with a power bus specification defining adjustable charging voltage and/or charging current.

In one embodiment, the power bus specification is one of the followings: USB Power Delivery Specification, PumpExpress or Quick Charge 3.0.

In one embodiment, the control unit delivers the control signal to control the charger circuit through a communication interface of a power bus specification defining adjustable charging voltage and/or charging current.

From another perspective, the present invention provides a charger circuit, comprising: a power conversion circuit, configured to operably receive a DC power supply, and convert a supply voltage of the DC power supply to generate a charging power to charge a battery, wherein the charging power includes a charging voltage and a charging current; and a control unit, configured to operably control the power conversion circuit, wherein in a charging period, the control unit senses a voltage drop of the charger circuit, and adjusts the supply voltage according to the voltage drop to reduce the voltage drop; wherein the voltage drop indicates a difference between the supply voltage and the charging voltage.

From another perspective, the present invention provides a charging control method for controlling a charging operation by a charger circuit for converting a supply voltage of a DC power supply to generate a charging power to charge a battery, the charging power having a charging voltage and a charging current; the charging control method comprising: in a charging period, sensing a voltage drop of the charger circuit; and adjusting the supply voltage according to the voltage drop to reduce the voltage drop; wherein the voltage drop indicates a difference between the supply voltage and the charging voltage.

In one embodiment, the step of reducing the voltage drop includes the following steps: (A) setting the supply voltage to an initial voltage; (B) checking whether the charging voltage reaches a predetermined voltage level; (C) when the charging voltage is lower than the predetermined voltage level, the charger circuit delivering a control signal to control the DC power supply to reduce the supply voltage; (D) checking whether the charging voltage or the charging current is reduced corresponding to the step (C), wherein when the charging voltage or the charging current is reduced in response to the step (C), entering step (E); (E) the charger circuit delivering the control signal to control the DC power supply to increase the supply voltage; and (F) checking whether the charging voltage and/or the charging current is increased in response to the step (E); wherein: after the step (D), when the charging voltage and the charging current are not reduced in response to the step (C), returning to step (B); after the step (F), when the charging voltage and/or the charging current is increased in response to the step (E), returning to step (B).

In one embodiment, after the step (F), when the charging voltage or the charging current is not increased corresponding to the step (E), returning to step (E).

In one embodiment, the charging control method further includes step (D1): after the step (D), when the charging voltage and the charging current are not reduced in response to the step (C), waiting for a first predetermined time period before returning to step (B).

In one embodiment, the charging control method further includes step (F1): after the step (F), when the charging voltage and/or the charging current is increased in response to the step (E), waiting for a second predetermined time period before returning to step (B).

In one embodiment, the charging control method further includes step (F2): after the step (F), when the charging voltage or the charging current is not increased in response to the step (E), waiting for a third predetermined time period before returning to step (E).

In one embodiment, the charging control method further includes step (C1) and/or (E1), and step (G), wherein: the step (C1) includes: after the step (C), checking whether the supply voltage changes in response to the step (C), and entering the step (D) when the supply voltage changes in response to the step (C), otherwise entering the step (G); the step (E1) includes: after the step (E), checking whether the supply voltage changes in response to the step (E), and entering the step (F) when the supply voltage changes in response to the step (C), otherwise entering the step (G); wherein the step (G) includes at least one of the following operations: (1) stopping adjusting the supply voltage; (2) repetitively delivering the control signal to control the DC power supply for plural times and checking whether the supply voltage is increased or is reduced accordingly, wherein when a count number of repetitively delivering the control signal reaches a predetermined count number and the supply voltage is neither increased nor reduced accordingly, stopping adjusting the supply voltage; and/or (3) the charger circuit adjusting the charging current to a predetermined minimum current.

In one embodiment, during or after the step (B), when the charging voltage reaches the predetermined voltage level, stopping adjusting the supply voltage.

In one embodiment, during the step (C), the supply voltage is reduced by a predetermined voltage step, or during the step (E), the supply voltage is increased by a predetermined voltage step.

The objectives, technical details, features, and effects of the present invention will be better understood with regard to the detailed description of the embodiments below.

### BRIEF DESCRIPTION OF THE DRAWINGS

FIG. 1A shows a schematic diagram of a prior art charger circuit.

FIG. 1B shows schematic waveforms of charging phases of a prior art charger circuit.

FIG. 2 shows a schematic diagram of one embodiment of the charging apparatus of the present invention.

FIGS. 3A and 3B show flow charts of embodiments of the charging control method of the present invention.

FIG. 4 shows schematic waveforms of charging phases of the charging apparatus of the present invention.

FIG. 5 shows a flow chart of one embodiment of the charging control method of the present invention.

FIG. 6 shows a schematic diagram of one embodiment of the charging apparatus of the present invention.

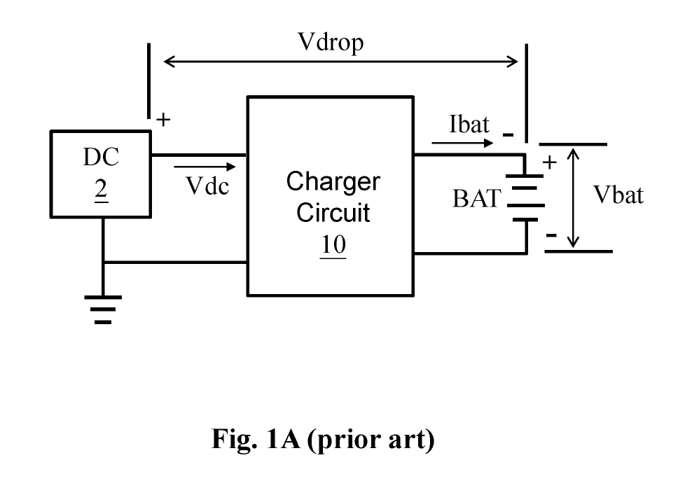

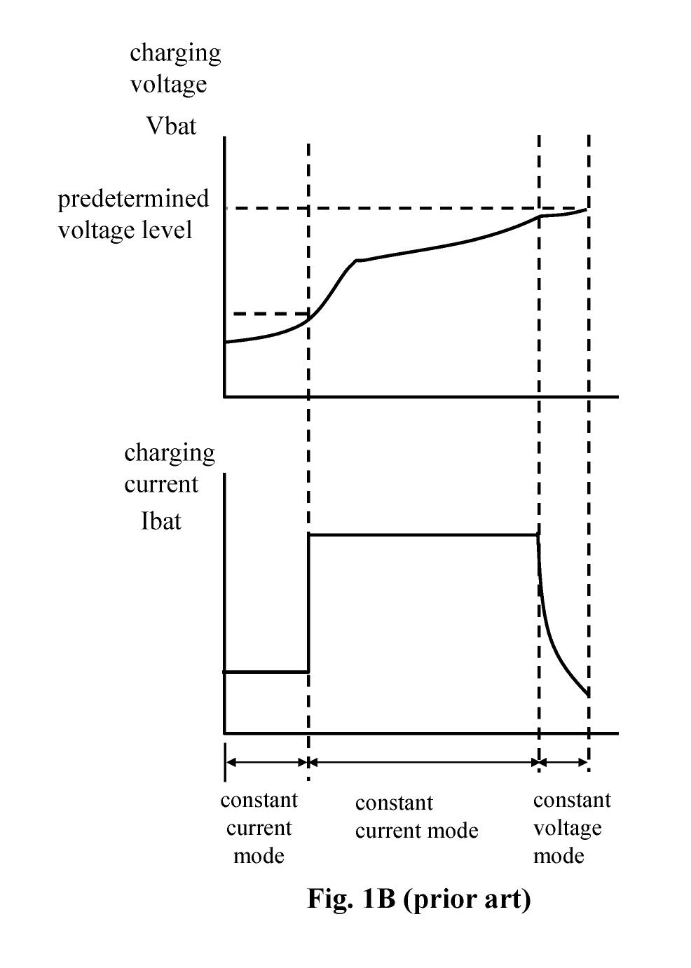

### DESCRIPTION OF THE PREFERRED EMBODIMENTS

The drawings as referred to throughout the description of the present invention are for illustration only, to show the interrelations between the circuits and the signal waveforms, but not drawn according to actual scale.

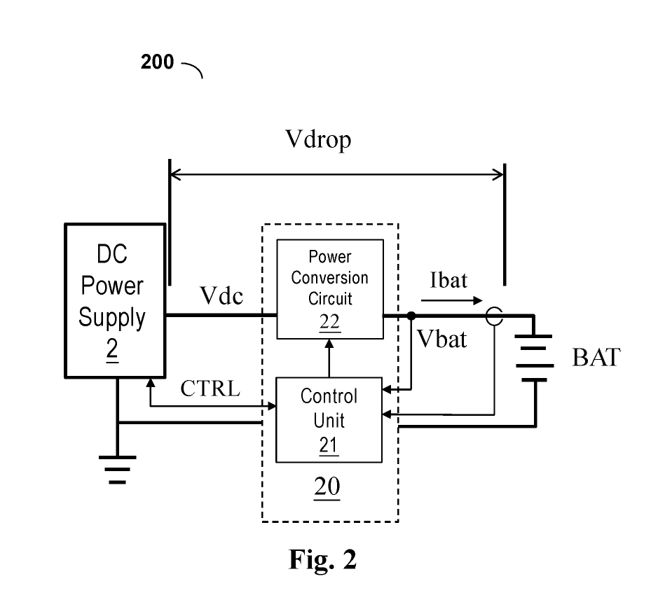

FIG. 2 shows one embodiment of the charging apparatus and the charger circuit thereof according to the present invention (charging apparatus 200, charger circuit 20). The charging apparatus comprises a DC power supply 2 and a charger circuit 20. The charger circuit 20 converts a supply voltage Vdc of the DC power supply 2 to a charging power to charge a battery BAT.

The charger circuit 20 includes a power conversion circuit 22 and a control unit 21. The power conversion circuit 22 is configured to operably convert the supply voltage Vdc of the DC power supply 2 to a charging power to charge the battery BAT, wherein the charging power includes a charging voltage Vbat and a charging current Ibat. The control unit 21 is configured to operably control the power conversion circuit 22. In a charging period, the control unit 21 senses a voltage drop Vdrop of the charger circuit 20, and adjusts the supply voltage Vdc according to the voltage drop Vdrop to reduce the voltage drop Vdrop to be as low as possible. The voltage drop Vdrop indicates a difference between the supply voltage Vdc and the charging voltage Vbat.

In one embodiment, the control unit 21 generates a control signal CTRL according to the charging voltage Vbat and/or the charging current Ibat, and delivers the control signal CTRL to the DC power supply 2 to control the DC power supply 2 to adjust the supply voltage Vdc. The power conversion circuit 22 can be, for example, a linear power conversion circuit or switching power conversion circuit.

In one embodiment, the DC power supply 2, the charger circuit 20 and the control unit are compliant with a power bus specification with adjustable charging voltage Vbat and/or charging current Ibat, such as USB Power Delivery Specification, PumpExpress or Quick Charge 3.0. In one embodiment, the DC power supply 2 can be an adaptor, a power bank or a power supply circuit compliant with any one of the aforementioned power bus specifications. In one embodiment, the control unit 21 delivers the control signal CTRL to control the DC power supply 2 through a communication interface compliant with any one of the aforementioned power bus specifications.

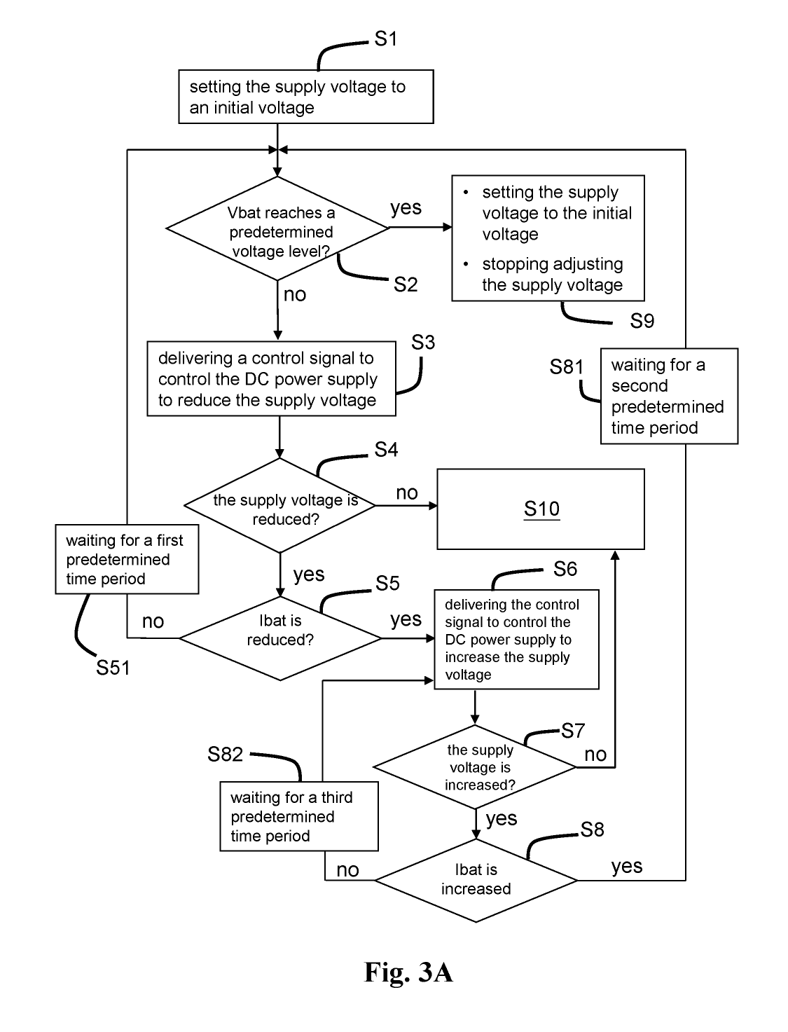

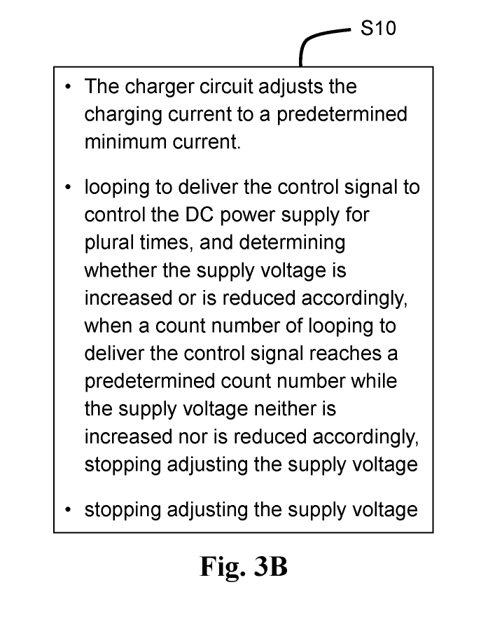

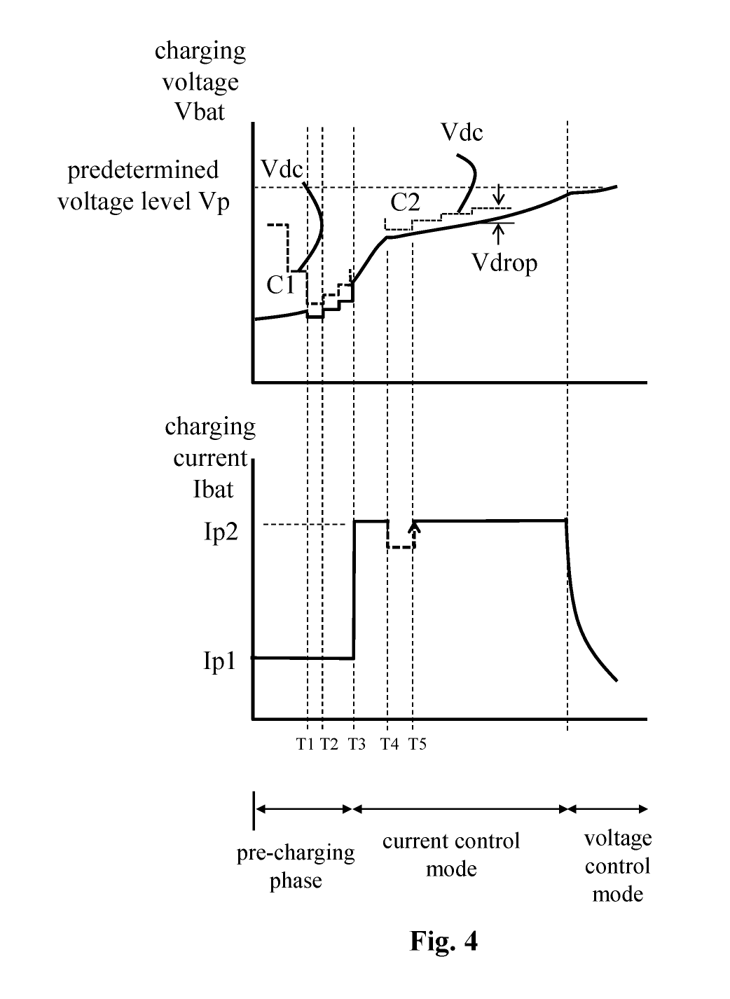

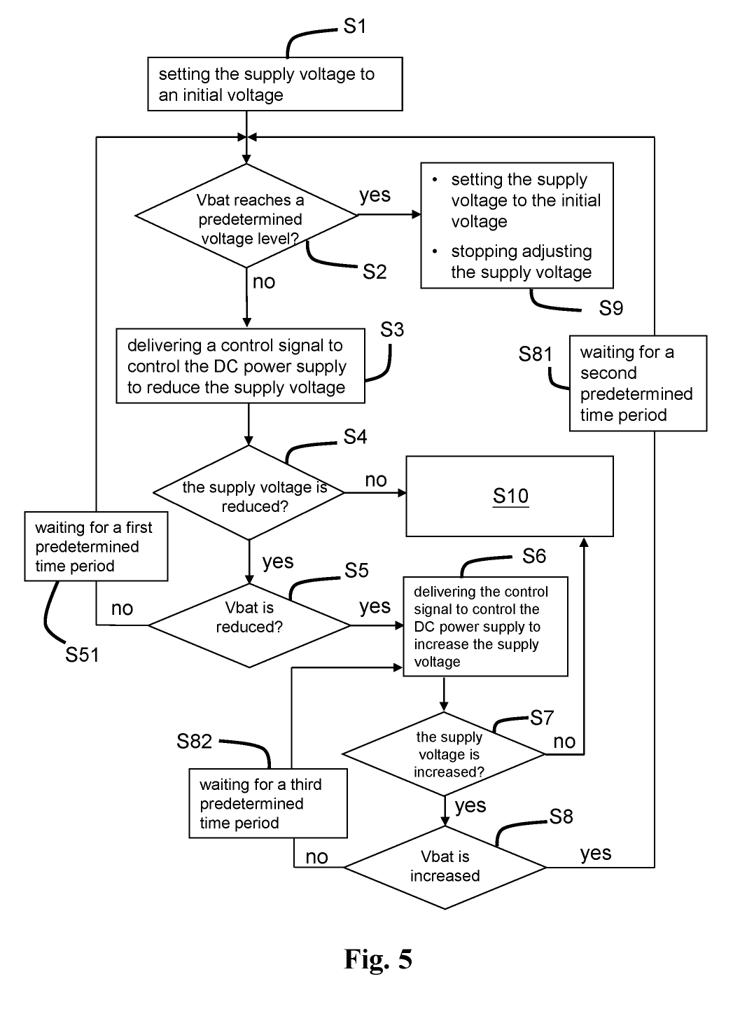

FIGS. 3A, 3B and 5 show control flow charts of two embodiments of the charger circuit of the present invention, which also illustrate the charging control method of the present invention. FIG. 4 shows schematic waveforms in the charging phases of the charging apparatus of the present invention. As shown in the figures, in step S1, the charger circuit 20 receives the supply voltage Vdc to charge the battery BAT; in one embodiment, the supply voltage Vdc can be set to an initial voltage (for example but not limited to 5V). After the charging process starts, the charger circuit 20 determines whether the charging voltage Vbat reaches a predetermined voltage level Vp (corresponding to step S2). Referring to FIG. 4, the predetermined voltage level Vp for example can be, but is not limited to, a fully charged voltage level of the battery BAT (such as 4.2V, or a predefined voltage level). In one embodiment, after the step S2, when the charging voltage reaches the predetermined voltage level Vp, the charger circuit 20 can enter the step S9, wherein for example the supply voltage Vdc can be set to the initial voltage (such as 5V) or the adjustment of the supply voltage Vdc can be stopped.

On the other hand, when the charging voltage Vbat is lower than the predetermined voltage level Vp, which means that the charging process is still in the main charging phase (such as in a current control mode, referring to FIG. 4), the voltage drop between the supply voltage Vbat and the charging voltage Vbat may be quite large to cause high power loss and overheat. According to the present invention, when the charging voltage Vbat is lower than the predetermined voltage level Vp, the charger circuit 20 delivers the control signal CTRL to control the DC power supply 2 to reduce the supply voltage Vdc (corresponding to step S3). Next, the charger circuit 2 determines whether the supply voltage Vdc is reduced accordingly (corresponding to step S4). In other words, when the charging voltage Vbat is lower than the predetermined voltage level Vp, it indicates that the voltage drop Vdrop is too large, and according to the present invention, the charger circuit 20 delivers the control signal CTRL to the DC power supply 2 to reduce the supply voltage Vdc, such that the voltage drop can be reduced.

However, in some cases, the DC power supply 2 may not be controllable by the control signal CTRL to reduce the supply voltage, for example due to incompatible configurations or uncontrollability of the DC power supply 2. When the supply voltage Vdc is not reduced according to the control signal CTRL, the charger circuit 20 can perform at least one of the following operations (corresponding to step S10, FIG. 3B): (1) stopping adjusting the supply voltage Vdc; (2) repetitively delivering the control signal CTRL to the DC power supply 2 for plural times and checking whether the supply voltage Vdc is increased or reduced accordingly, wherein when a count number of repetitively delivering the control signal CTRL reaches a predetermined count number and the supply voltage Vdc is neither increased nor reduced accordingly, stopping adjusting the supply voltage Vdc; and/or (3) the charger circuit 20 adjusting the charging current Ibat to a predetermined minimum current Ipmi to charge the battery BAT; that is, when the power cannot be reduced by controlling the supply voltage Vbat, the charger circuit 2 can reduce the charging current Ibat to lower the power loss instead. On the other hand, when supply voltage Vdc can be reduced in response to the control signal CTRL, the charger circuit 20 checks whether the charging current Ibat (step S5, FIG. 3A) or the charging voltage Vbat (step S5, FIG. 3B) is reduced as the supply voltage Vdc is reduced. If the charging current Ibat or the charging voltage Vbat is not reduced as the supply voltage Vdc is reduced (step S3), the charger circuit 20 can return to the step S2. In one embodiment, after step S5, when the charging current Ibat (or the charging voltage Vbat) is not reduced in response to step S3, the charger circuit 20 further waits for a predetermined time period (step 51, for example but not limited to 10 seconds) before returning to step S2. Or, in another embodiment, the charger circuit 20 can stop adjusting the supply voltage Vdc in this case (the charger circuit 20 still operates but does not proactively adjust the supply voltage Vdc).

If the charging current Ibat or the charging voltage Vbat is reduced as the supply voltage Vdc is reduced, the charger circuit 30 delivers the control signal to the DC power supply 2 to increase the supply voltage Vdc (step S6). That the charging current Ibat or the charging voltage Vbat is reduced as the supply voltage Vdc is reduced indicates that the reduction of the supply voltage Vdc causes a negative effect; for example, the voltage drop Vdrop may be lower than a minimum value required for the power conversion circuit 22 to operate normally, such that the charging current Ibat is lower than the predetermined charging current level Ip2 in the current control mode (FIG. 4), or lower than the predetermined current level Ip1 in the pre-charging phase, or the charging voltage Vbath is lower than the predetermined charging voltage in the voltage control mode; whichever case it is, it leads to lower charging efficiency. Under such circumstance, the supply voltage Vdc should not stay at the present level. Instead, the supply voltage Vdc should be increased. According to the present invention, the charger circuit 20 can deliver the control signal CTRL to control the DC power supply 2 to increase the supply voltage Vdc (step S6).

After step S6, the charger circuit 20 checks again whether the supply voltage Vdc is increased in response to the control signal CTRL (step S7). If the supply voltage Vdc is increased in response to the control signal CTRL, the charger circuit 20 then determines whether the charging voltage Vbat (or the charging current Ibat) is increased in response to the increasing of the supply voltage Vdc (step S8). If the charging voltage Vbat or the charging current Ibat (corresponding to S8 in FIG. 3A or S8 in FIG. 5 respectively) is increased accordingly, it means that the present level of the supply voltage Vdc reaches its optimum value after steps S3-S6. Next, in one embodiment, the charger circuit 20 can return to step S2 to keep checking whether the charging voltage Vbat reaches the predetermined voltage level Vp. When the charging voltage Vbat reaches the predetermined voltage level Vp, the charger circuit 20 stops adjusting the supply voltage Vdc (step S9). At this moment, the main charging phase is completed. In one embodiment, in step 9, the DC power supply 2 can be set to the initial voltage. Next, the battery BAT can be charged by for example but not limited to a voltage control mode (FIG. 4).

In one embodiment, after step S8, when the charging voltage Vbat (or the charging current Ibat) is increased in response to the increasing of the supply voltage Vdc, the charger circuit 20 can further wait for a second predetermined time period (step S81, for example but not limited to 30 seconds) before returning to step S2. In other words, since the present level of the supply voltage Vdc has reached its optimum value after steps S3-S6, the charger circuit 20 can keep charging the battery BAT with the present optimized level of the supply voltage Vdc for a certain period of time before starting the next iteration of checking and adjusting of the supply voltage Vdc again.

In step S7, if the supply voltage Vdc is determined not being increased in response to the control signal CTRL, in one embodiment, the charger circuit 20 can stop adjusting the supply voltage Vdc (the charger circuit 20 still operates but does not proactively adjust the supply voltage Vdc). Or in another embodiment, the charger circuit 20 can go to step 10. If the DC power supply 2 does not adjust the supply voltage Vdc after receiving the control signal CTRL in step S6, it probably indicates that the supply voltage Vdc can be adjusted lower but not higher. In this case, in one embodiment, the charger circuit 20 can generate an alarm signal.

When the supply voltage Vdc is increased in response to the control signal CTRL (step S7), but the charging voltage (or the charging current) is not increased as the supply voltage Vdc is increased (step S8), in one embodiment, the charger circuit 20 can stop adjusting the supply voltage Vdc (the charger circuit 20 still operates but does not proactively adjust the supply voltage Vdc). In another embodiment, the charger circuit 20 can return to step S6 to try to deliver the control signal CTRL to increase the supply voltage Vdc. In one embodiment, the charger circuit 20 can wait for a predetermined time period (step 82, for example but not limited to 10 seconds) before returning to step S6.

In one embodiment, the charger circuit 20 can increase or reduce the supply voltage Vdc by a predetermined voltage step when adjusting the supply voltage Vdc (e.g. during step S3 or S6); that is, the adjustment is a step-by-step adjustment, wherein each adjustment increases or reduces the supply voltage Vdc by a predetermined voltage step.

FIG. 4 shows schematic waveforms of charging phases of the charging apparatus of the present invention. As shown in the figures, in one embodiment, at the beginning during the charging curve C1, the DC power supply 2 reduces the supply voltage step by step according to the control signal CTRL so that the level of the supply voltage Vdc is close to the level of the charging voltage Vbat to reduce the voltage drop therebetween for higher power efficiency. However, when the supply voltage Vdc is reduced to a certain extent, the charging voltage Vbat may also be reduced accordingly (for example at T1, the charging voltage Vbat is lower than its level before T1). In this case, as step S6 (e.g. FIG. 5) indicates, the charger circuit 20 delivers the control signal CTRL to control the DC power supply 2 to increase the supply voltage Vdc, so as to increase the charging voltage Vbat (such as at T2 or T3 shown in FIG. 4), while maintaining the voltage drop Vdrop within a desired range.

Still referring to FIG. 4, at the beginning during the charging curve C2, when the supply voltage Vdc is controlled to be reduced, the voltage drop Vdrop may also be reduced to an extent that the charging current Ibat starts to drop accordingly (for example at T4, the charging current Ibat is lower than its level before T4). In this case, as step S6 (e.g. FIG. 3A) indicates, the charger circuit 20 delivers the control signal CTRL to control the DC power supply 2 to increase the supply voltage Vdc, so as to increase the charging voltage Vbat (such as at T5 shown in FIG. 4) such that the charging current Ibat can be raised to and maintained at its predetermined level (i.e. Ip2 at T5), while controlling the voltage drop Vdrop to be within a desired range.

The present invention is advantageous over the prior art in that the voltage drop Vdrop can be maintained within a certain range to lower the power loss while the charging voltage Vbat and/or the charging current can be kept at the desired level.

Note that the steps shown in FIGS. 3A and 5 are for illustrative purpose but not for limiting the scope of the present invention. Those skilled in this art can readily conceive variations and modifications within the spirit of the present invention.

As an example, in one embodiment, step S4 in FIGS. 3A and 5 can be omitted, that is, step S3 (reducing the supply voltage Vdc) is directly followed by step S5 (FIGS. 3A and 5) without checking the supply voltage Vdc. Similarly, in one embodiment, step S7 in FIGS. 3A and 5 can be omitted, that is, step S6 (increasing the supply voltage Vdc) is directly followed by step S8 (FIGS. 3A and 5) without checking the supply voltage Vdc.

As another example, though as shown in FIGS. 3A and 5, the “checking whether the charging voltage Vbat reaches a predetermined voltage level Vp” is performed in step S2, however, the charger circuit 20 can determine whether the charging voltage Vbat reaches the predetermined voltage level Vp whenever necessary. In other words, during any step or between any two steps, whenever the charging voltage Vbat reaches the predetermined voltage level Vp, the charger circuit 20 can stop adjusting the supply voltage Vdc (the charger circuit 20 still operates but does not proactively adjust the supply voltage Vdc). For example, when the supply voltage Vdc is reduced in response to the control signal CTRL but the charging voltage Vbat (or the charging current Ibat) is not reduced (S5 in FIG. 3A or S5 in FIG. 5), the charger circuit 20 can enter step S2 to check whether the charging voltage Vbat reaches the predetermined voltage level Vp.

Note that, each of the execution steps shown in FIGS. 3A and 5 (such as S1, S3, S10, S6, S9, S10, S51, S81 or S82) is not limited to being executed only once or at an instant; any one of these steps can be executed for plural times or performed for a certain duration. Each of the checking steps (such as S2, S4, S5, S7 or S8) can correspondingly check the number of times or the length of the duration.

As an example, after the DC power supply 2 receives the control signal CTRL to reduce the supply voltage Vdc (e.g. S3), and it is found that the supply voltage Vdc is not reduced, the method does not immediately go to step S10. In one embodiment, it is checked whether the supply voltage Vdc is reduced for a predetermined time period in step S4, and the charger circuit 20 enters step S10 after it is found that the supply voltage Vdc is not reduced within the predetermined time period.

As another example, after the DC power supply 2 receives the control signal CTRL to increase the supply voltage Vdc (e.g. S6), and it is found that the supply voltage Vdc is not increased, the method does not immediately go to step S10. In one embodiment, it is checked whether the supply voltage Vdc is increased for a predetermined time period in step S6, and the charger circuit 20 enters step S10 after it is found that the supply voltage Vdc is not increased within the predetermined time period.

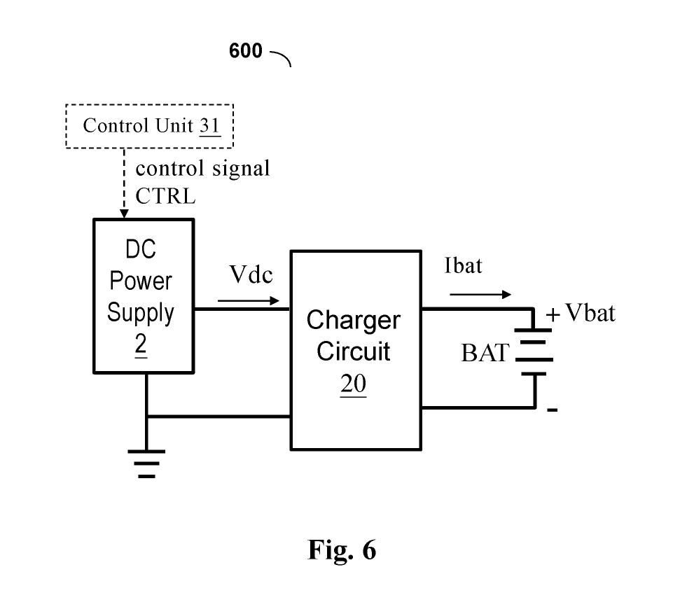

The control unit 21 is not limited to being located inside the charger circuit 20. In one embodiment, the control signal CTRL can be generated according the charging voltage Vbat or the charging current Ibat by a control unit 31 (as shown in FIG. 6) outside the charger circuit 20.

In one embodiment, the step wherein the charger circuit 20 adjusts the charging current Ibat to a predetermined minimum current Ipmi to charge the battery BAT is not limited to adjusting the charging current Ibat one-step to the predetermined minimum current Ipmi. In one embodiment, the charging current Ibat can be adjusted gradually till the predetermined minimum current Ipmi, stepwisely or continuously.

In one embodiment, the steps in the embodiments in FIGS. 3A and 5 can be combined together. As shown in FIG. 4, the charger circuit 20 can determine whether the charging voltage Vbat is reduced and whether the charging current Ibat is reduced at the same time during the charging process.

The present invention has been described in considerable detail with reference to certain preferred embodiments thereof. It should be understood that the description is for illustrative purpose, not for limiting the scope of the present invention. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. Furthermore, those skilled in this art can readily conceive variations and modifications within the spirit of the present invention. For example, other steps can be inserted between any two steps in the aforementioned embodiments as long as the inserted steps do not adversely affect the primary objective according to the spirit of the present invention. As another example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. The spirit of the present invention should cover all such and other modifications and variations, which should be interpreted to fall within the scope of the following claims and their equivalents.

What is claimed is:

1. A charging control method for controlling a charging operation by a charger circuit for converting a supply voltage of a DC power supply to generate a charging power to charge a battery, the charging power having a charging voltage and a charging current; the charging control method comprising:
in a charging period, sensing a voltage drop of the charger circuit; and
adjusting the supply voltage according to the voltage drop to reduce the voltage drop;
wherein the voltage drop indicates a difference between the supply voltage and the charging voltage.

2. The charging control method of claim 1, wherein the step of reducing the voltage drop includes the following steps:
(A) setting the supply voltage to an initial voltage;
(B) checking whether the charging voltage reaches a predetermined voltage level;
(C) when the charging voltage is lower than the predetermined voltage level, the charger circuit delivering a control signal to control the DC power supply to reduce the supply voltage;
(D) checking whether the charging voltage or the charging current is reduced corresponding to the step (C), wherein when the charging voltage or the charging current is reduced in response to the step (C), entering step (E);
(E) the charger circuit delivering the control signal to control the DC power supply to increase the supply voltage; and
(F) checking whether the charging voltage and/or the charging current is increased in response to the step (E);
wherein:
after the step (D), when the charging voltage and the charging current are not reduced in response to the step (C), returning to step (B);
after the step (F), when the charging voltage and/or the charging current is increased in response to the step (E), returning to step (B).

3. The charging control method of claim 2, wherein after the step (F), when the charging voltage or the charging current is not increased in response to the step (E), returning to step (E).

4. The charging control method of claim 2, further comprising step (D1): after the step (D), when the charging voltage and the charging current are not reduced in response to the step (C), waiting for a first predetermined time period before returning to step (B).

5. The charging control method of claim 2, further comprising step (F1): after the step (F), when the charging voltage and/or the charging current is increased in response to the step (E), waiting for a second predetermined time period before returning to step (B).

6. The charging control method of claim 3, further comprising step (F2): after the step (F), when the charging voltage or the charging current is not increased in response to the step (E), waiting for a third predetermined time period before returning to step (E).

7. The charging control method of claim 2, further comprising step (C1) and/or (E1), and step (G), wherein:
the step (C1) includes: after the step (C), checking whether the supply voltage changes in response to the step (C), and entering the step (D) when the supply voltage changes in response to the step (C), otherwise entering the step (G);
the step (E1) includes: after the step (E), checking whether the supply voltage changes in response to the step (E), and entering the step (F) when the supply voltage changes in response to the step (C), otherwise entering the step (G);
wherein the step (G) includes at least one of the following operations:
(1) stopping adjusting the supply voltage;
(2) repetitively delivering the control signal to control the DC power supply for plural times and checking whether the supply voltage is increased or is reduced accordingly, wherein when a count number of repetitively delivering the control signal reaches a predetermined count number and the supply voltage is neither increased nor reduced accordingly, stopping adjusting the supply voltage; and/or
(3) the charger circuit adjusting the charging current to a predetermined minimum current.

8. The charging control method of claim 2, wherein during or after the step (B), when the charging voltage reaches the predetermined voltage level, stopping adjusting the supply voltage.

9. The charging control method of claim 2, wherein during the step (C), the supply voltage is reduced by a predetermined voltage step, or during the step (E), the supply voltage is increased by a predetermined voltage step.

10. A charging apparatus, comprising:
a DC power supply; and
a charger circuit configured to be coupled to the DC power supply, wherein the charger circuit includes:
a power conversion circuit, configured to operably receive the DC power supply, and convert a supply voltage of the DC power supply to generate a charging power to charge a battery, wherein the charging power includes a charging voltage and a charging current; and
a control unit, configured to operably control the power conversion circuit, wherein in a charging period, the control unit senses a voltage drop of the charger circuit, and adjusts the supply voltage according to the voltage drop to reduce the voltage drop; wherein the voltage drop indicates a difference between the supply voltage and the charging voltage.

11. The charging apparatus of claim 10, wherein the control unit adjusts the supply voltage to reduce the voltage drop by steps including:
(A) setting the supply voltage to an initial voltage;
(B) checking whether the charging voltage reaches a predetermined voltage level;
(C) when the charging voltage is lower than the predetermined voltage level, the charger circuit delivering a control signal to control the DC power supply to reduce the supply voltage;
(D) checking whether the charging voltage or the charging current is reduced corresponding to the step (C), wherein when the charging voltage or the charging current is reduced in response to the step (C), entering step (E);
(E) the charger circuit delivering the control signal to control the DC power supply to increase the supply voltage; and
(F) checking whether the charging voltage and/or the charging current is increased in response to the step (E);
wherein:
after the step (D), when the charging voltage and the charging current are not reduced in response to the step (C), returning to step (B);
after the step (F), when the charging voltage and/or the charging current is increased in response to the step (E), returning to step (B).

12. The charging apparatus of claim 11, wherein after the step (F), when the charging voltage or the charging current is not increased in response to the step (E), returning to step (E).

13. The charging apparatus of claim 11, wherein the step of the control unit adjusting the supply voltage to reduce the voltage drop further includes step (D1): after the step (D), when the charging voltage and the charging current are not reduced corresponding to the step (C), waiting for a first predetermined time period before returning to step (B).

14. The charging apparatus of claim 11, wherein the step of the control unit adjusting the supply voltage to reduce the voltage drop further includes step (F1): after the step (F), when the charging voltage and/or the charging current is increased in response to the step (E), waiting for a second predetermined time period before returning to step (B).

15. The charging apparatus of claim 12, wherein the step of the control unit adjusting the supply voltage to reduce the voltage drop further includes step (F2): after the step (F), when the charging voltage or the charging current is not increased in response to the step (E), waiting for a third predetermined time period before returning to step (E).

16. The charging apparatus of claim 11, wherein the step of the control unit adjusting the supply voltage to reduce the voltage drop further includes step (C1) and/or (E1), and step (G), wherein:
the step (C1) includes: after the step (C), checking whether the supply voltage changes in response to the step (C), and entering the step (D) when the supply voltage changes in response to the step (C), otherwise entering the step (G);
the step (E1) includes: after the step (E), checking whether the supply voltage changes in response to the step (E), and entering the step (F) when the supply voltage changes in response to the step (C), otherwise entering the step (G);
wherein the step (G) includes at least one of the following operations:
(1) stopping adjusting the supply voltage;
(2) repetitively delivering the control signal to control the DC power supply for plural times and checking whether the supply voltage is increased or is reduced accordingly, wherein when a count number of repetitively delivering the control signal reaches a predetermined count number and the supply voltage is neither increased nor reduced accordingly, stopping adjusting the supply voltage; and/or
(3) the charger circuit adjusting the charging current to a predetermined minimum current.

17. The charging apparatus of claim 11, wherein during or after the step (B), when the charging voltage reaches the predetermined voltage level, stopping adjusting the supply voltage.

18. The charging apparatus of claim 11, wherein during the step (C), the supply voltage is reduced by a predetermined voltage step, or during the step (E), the supply voltage is increased by a predetermined voltage step.

19. The charging apparatus of claim 10, wherein the DC power supply is one of the followings: an adaptor, a power bank, or a power supply circuit, which is compliant with a power bus specification defining adjustable charging voltage and/or charging current.

20. The charging apparatus of claim 19, wherein the power bus specification is one of the followings: USB Power Delivery Specification, PumpExpress or Quick Charge 3.0.

21. The charging apparatus of claim 11, wherein the control unit delivers the control signal to control the charger circuit through a communication interface of a power bus specification defining adjustable charging voltage and/or charging current.

22. A charger circuit, comprising:
a power conversion circuit, configured to operably receive a DC power supply, and convert a supply voltage of the DC power supply to generate a charging power to charge a battery, wherein the charging power includes a charging voltage and a charging current; and
a control unit, configured to operably control the power conversion circuit, wherein in a charging period, the control unit senses a voltage drop of the charger circuit, and adjusts the supply voltage according to the voltage drop to reduce the voltage drop; wherein the voltage drop indicates a difference between the supply voltage and the charging voltage.

23. The charger circuit of claim 22, wherein the control unit adjusts the supply voltage to reduce the voltage drop by the following steps:
(A) setting the supply voltage to an initial voltage;
(B) checking whether the charging voltage reaches a predetermined voltage level;
(C) when the charging voltage is lower than the predetermined voltage level, the charger circuit delivering a control signal to control the DC power supply to reduce the supply voltage;
(D) checking whether the charging voltage or the charging current is reduced corresponding to the step (C), wherein when the charging voltage or the charging current is reduced in response to the step (C), entering step (E);
(E) the charger circuit delivering the control signal to control the DC power supply to increase the supply voltage; and
(F) checking whether the charging voltage and/or the charging current is increased in response to the step (E);
wherein:
after the step (D), when the charging voltage and the charging current are not reduced in response to the step (C), returning to step (B);
after the step (F), when the charging voltage and/or the charging current is increased in response to the step (E), returning to step (B).

24. The charger circuit of claim 23, wherein after the step (F), when the charging voltage or the charging current is not increased in response to the step (E), returning to step (E).

25. The charger circuit of claim 23, wherein the step of the control unit adjusting the supply voltage to reduce the voltage drop further includes step (D1): after the step (D), when the charging voltage and the charging current are not reduced in response to the step (C), waiting for a first predetermined time period before returning to step (B).

26. The charger circuit of claim 23, wherein the step of the control unit adjusting the supply voltage to reduce the voltage drop further includes step (F1): after the step (F), when the charging voltage and/or the charging current is increased in response to the step (E), waiting for a second predetermined time period before returning to step (B).

27. The charger circuit of claim 24, wherein the step of the control unit adjusting the supply voltage to reduce the voltage drop further includes step (F2): after the step (F), when the charging voltage or the charging current is not increased in response to the step (E), waiting for a third predetermined time period before returning to step (E).

28. The charger circuit of claim 23, wherein the step of the control unit adjusting the supply voltage to reduce the voltage drop further includes step (C1) and/or (E1), and step (G), wherein:
the step (C1) includes: after the step (C), checking whether the supply voltage changes in response to the step (C), and entering the step (D) when the supply voltage changes in response to the step (C), otherwise entering the step (G);
the step (E1) includes: after the step (E), checking whether the supply voltage changes in response to the step (E), and entering the step (F) when the supply voltage changes in response to the step (C), otherwise entering the step (G);
wherein the step (G) includes at least one of the following operations:
(1) stopping adjusting the supply voltage;
(2) repetitively delivering the control signal to control the DC power supply for plural times and checking whether the supply voltage is increased or is reduced accordingly, wherein when a count number of repetitively delivering the control signal reaches a predetermined count number and the supply voltage is neither increased nor reduced accordingly, stopping adjusting the supply voltage; and/or
(3) the charger circuit adjusting the charging current to a predetermined minimum current.

29. The charger circuit of claim 23, wherein during or after the step (B), when the charging voltage reaches the predetermined voltage level, stopping adjusting the supply voltage.

30. The charger circuit of claim 23, during the step (C), the supply voltage is reduced by a predetermined voltage step, or during the step (E), the supply voltage is increased by a predetermined voltage step.

31. The charger circuit of claim 22, wherein the DC power supply is one of the followings: an adaptor, a power bank, or a power supply circuit, which is compliant with a power bus specification defining adjustable charging voltage and/or charging current.

32. The charger circuit of claim 31, wherein the power bus specification is one of the followings: USB Power Delivery Specification, PumpExpress or Quick Charge 3.0.

33. The charger circuit of claim 23, wherein the control unit delivers the control signal to control the charger circuit through a communication interface of a power bus specification defining adjustable charging voltage and/or charging current.
